(19) United States
(12) Patent Application Publication
(10) Pub. No.: US 2025/0364551 A1
(43) Pub. Date: Nov. 27, 2025

(54) ELECTRODE ACTIVE MATERIAL

(71) Applicant: TOYOTA JIDOSHA KABUSHIKI KAISHA, Toyota-shi (JP)

(72) Inventor: So YUBUCHI, Shizuoka-ken (JP)

(73) Assignee: TOYOTA JIDOSHA KABUSHIKI KAISHA, Toyota-shi (JP)

(21) Appl. No.: 19/021,220

(22) Filed: Jan. 15, 2025

(30) Foreign Application Priority Data
May 24, 2024 (JP) 2024-085080

(51) Int. Cl. H01M 4/525; C01G 53/01; C01G 53/502

(52) U.S. Cl. CPC H01M 4/525; C01G 53/01; C01G 53/502; C01P 2002/50; C01P 2002/60; C01P 2002/72; C01P 2002/76; C01P 2006/40

(57) ABSTRACT

An electrode active material in the present disclosure has at least one O2-like structure selected from among of an O2-type structure, a T#2-type structure, and an O6-type structure. The crystallite size of the O2-like structure that is measured by XRD is 400 Å or more and 1000 Å or less.

### CROSS-REFERENCE TO RELATED APPLICATION

This application claims priority to Japanese Patent Application No. 2024-085080 filed on May 24, 2024. The disclosure of the above-identified application, including the specification, drawings, and claims, is incorporated by reference herein in its entirety.

### BACKGROUND

### 1. Technical Field

The present application discloses an electrode active material.

### 2. Description of Related Art

An electrode active material having an O2-like structure is known. As disclosed in Japanese Unexamined Patent Application Publication No. 2023-182420 (JP 2023-182420 A), the electrode active material having the O2-like structure is obtained by the ion exchange of at least some of Na in a Na-containing oxide having a P2-type structure into Li.

### SUMMARY

The electrode active material having the O2-like structure has a room for improvement in the ratio of a capacity at a high potential to the total capacity.

As means for solving the above problem, the present application discloses a plurality of means described below.

### <Aspect 1>

An electrode active material having at least one O2-like structure selected from the group consisting of an O2-type structure, a T#2-type structure, and an O6-type structure, wherein a crystallite size of the O2-like structure is 400 Å or more and 1000 Å or less, the crystallite size being measured by XRD.

### <Aspect 2>

The electrode active material according to aspect 1, wherein a ratio of a capacity at 3 V or higher to a total capacity is 75.0% or more.

### <Aspect 3>

The electrode active material according to aspect 1 or 2, wherein the electrode active material contains Li, O, and at least one element selected from the group consisting of Ni, Mn, and Co, as constituent elements.

### <Aspect 4>

The electrode active material according to aspect 3, wherein the electrode active material has a chemical composition shown as LiₐNa_{b}Niₓ₋ₚCo_{y-q}Mn_{z-r}M_{p+q+r}O₂ (0<a<1.00, 0≤b≤0.20, 0.15<x<0.35, 0.15<y<0.45, 0.25<<<0.55, x+y+z=1, 0≤p+q+r<0.17, and an element M is at least one element selected from the group consisting of B, Mg, Al, K, Ca, Ti, V, Cr, Fe, Cu, Zn, Ga, Ge, Sr, Y, Zr, Nb, Mo, and W).

### <Aspect 5>

The electrode active material according to aspect 4, wherein 0.70<a<1.00 is satisfied.

The electrode active material in the present disclosure easily increases the ratio of a capacity at a high potential to the total capacity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of the configuration of a battery;

FIG. 2 shows X-ray diffraction patterns of electrode active materials according to Examples 1 and 2 and Comparative Example 1;

FIG. 3 shows X-ray diffraction patterns of electrode active materials according to Example 3 and Comparative Example 2;

FIG. 4 shows an X-ray diffraction pattern of an electrode active material according to Example 4; and

FIG. 5 shows the relation between the crystallite size of an O2-like structure that is measured by XRD and the ratio of a capacity at 3 V or higher to the total capacity.

### DETAILED DESCRIPTION OF EMBODIMENTS

An embodiment of an electrode active material and the like in the present disclosure will be described below. The electrode active material and the like in the present disclosure are not limited to the embodiment described below.

### 1. Electrode Active Material

An electrode active material according to the embodiment has at least one O2-like structure selected from among an O2-type structure, a T#2-type structure, and an O6-type structure. A crystallite size of the O2-like structure that is measured by XRD is 400 Å or more and 1000 Å or less.

### 1.1 Crystal Structure

The electrode active material according to the embodiment has at least one O2-like structure selected from among an O2-type structure (which belongs to a space group P63mc), a T#2-type structure (which belongs to a space group Cmca), and an O6-type structure (which belongs to a space group R-3m, has a c-axis length of 2.5 nm or more and 3.5 nm or less, typically, an a-axis-length of 2.9 nm or more and 3.0 nm or less, and is different from an O3-type structure belonging to the space group R-3m similarly). The electrode active material may have the O2-like structure as a main phase.

### 1.2 Crystallite Size

In the electrode active material according to the embodiment, the crystallite size of the O2-like structure that is measured by XRD is 400 Å or more and 1000 Å or less. According to the knowledge of the inventor, in the case where the crystallite size of the O2-like structure that is measured by XRD is 400 Å or more, the ratio of a capacity at a high potential to the total capacity increases, and the energy density easily improves. The size of the crystallite may be 900 Å or less, 850 Å or less, 800 Å or less, 750 Å or less, 700 Å or less, 650 Å or less, 600 Å or less, 550 Å or less, or 500 Å or less.

In the present application, the crystallite size of the O2-like structure in the electrode active material is measured by XRD, as follows. An X-ray diffraction pattern for which CuKα is used as a radiation source is acquired about the electrode active material, and the crystallite size of the O2-like structure is evaluated from an X-ray diffraction peak deriving from the (002) plane of the O2-type structure, an X-ray diffraction peak deriving from the (002) plane of the T#2-type structure, or an X-ray diffraction peak deriving from the (006) plane of the O6-type structure, based on the Scherrer formula, using PDXL2 software (made by Rigaku Corporation). In the case where a plurality of X-ray diffraction peaks of the X-ray diffraction peak deriving from the (002) plane of the O2-type structure, the X-ray diffraction peak deriving from the (002) plane of the T#2-type structure, and the X-ray diffraction peak deriving from the (006) plane of the O6-type structure is observed in the X-ray diffraction pattern, the crystallite diameter is evaluated based on a main peak (a peak having the highest peak intensity) of the plurality of peaks. Even if a plurality of peaks is overlapped, the crystallite diameter can be evaluated based on the overlapped peaks.

In the electrode active material according to the embodiment, one crystallite may form one particle by itself, or a plurality of crystallites may form one particle. In other words, the electrode active material according to the embodiment may include (1) a single-crystal particle that exists independently, (2) an aggregate (secondary particle) constituted by a plurality of single-crystal particles, (3) a polycrystal particle including a plurality of crystallites, or (4) an aggregate (secondary particle) constituted by a plurality of polycrystal particles. Particularly, in the case where the electrode active material includes a polycrystal particle, especially, a spherical polycrystal particle described later, an even higher performance is easily secured as the electrode active material. The electrode active material according to the embodiment can be obtained by the ion exchange of at least some of Na in a Na-containing oxide having a P2-type structure into Li, as described later. The P2-type structure has a hexagonal system, has a high diffusion coefficient for a Na ion, and easily causes the crystal growth in a specific direction. Therefore, generally, a crystallite having the P2-type structure has a shape (for example, a plate shape) in which the direction of the crystal growth is biased to a specific direction. In the case where a crystallite having the O2-like structure is obtained by the ion exchange of Na in the P2-type crystallite in the direction of the crystal growth in this way biased to a specific direction into Li, an end portion (an end portion in the above direction of the crystal growth) of the crystallite having the O2-like structure easily serves as an entrance and exit for intercalation. In other words, in the case where the electrode active material includes polycrystal particles, it is possible to expect an effect of the decrease in reaction resistance due to the increase in the numbers of entrances and exits for intercalation that are included in one particle, an effect of the decrease in diffusion resistance due to the shortening of the movement distance of lithium ions, an effect of the reduction in the expansion-contraction amount of the whole particle at the time of charge and discharge, and the like.

As described above, the crystallite of the Na-containing oxide having the P2-type structure easily has a plate shape. That is, the Na-containing oxide having the P2-type structure can become plate-shaped particles, or can become spherical particles by the coupling of small plate-shaped crystallites with each other. In other words, one electrode active material particle, as a whole, may be a plate-shaped single-crystal particle, or may be spherical polycrystal particle. The spherical polycrystal particle includes a plurality of crystallites on the surface. In the case where the electrode active material includes the spherical polycrystal particle, the spheroidizing is thought to reduce the flexion degree and decrease the lithium-ion conduction resistance. Thereby, for example, the rate characteristic of the battery improves, and the reversible capacity easily increases. In the present application, the “spherical particle” means a particle for which the circularity degree is 0.80 or more. The circularity degree of the particle may be 0.81 or more, 0.82 or more, 0.83 or more, 0.84 or more, 0.85 or more, 0.86 or more, 0.87 or more, 0.88 or more, 0.89 or more, or 0.90 or more. The circularity degree of the particle is defined as 4πS/L². Here, S is the orthographically-projected area of the particle, and L is the perimeter of an orthographically-projected image of the particle. The circularity degree of the particle can be evaluated by observing the external appearance of the particle with a scanning electron microscope (SEM), a transmission electron microscope (TEM) or an optical microscope.

### 1.3 Chemical Composition

The chemical composition of the electrode active material according to the embodiment is not particularly limited, as long as the O2-like structure can be maintained. For example, the electrode active material may contain Li, O, and at least one element selected from among Mn, Ni, and Co, as constituent elements. Particularly, in the case where the electrode active material contains Li, Mn, Ni, Co, and O as constituent elements, a higher performance is easily obtained. The electrode active material may have a chemical composition shown as LiₐNa_{b}Niₓ₋ₚCo_{y-q}Mn_{z-r}M_{p+q+r}O₂ (0<a<1.00, 0≤b≤0.20, 0.15<x<0.35, 0.15<y<0.45, 0.25<z<0.55, x+y+z=1, 0≤p+q+r<0.17, and an element M is at least one element selected from among B, Mg, Al, K, Ca, Ti, V, Cr, Fe, Cu, Zn, Ga, Ge, Sr, Y, Zr, Nb, Mo, and W). In the case where the electrode active material has this chemical composition, the O2-like structure is easily maintained, and a higher performance is easily secured. In the above chemical composition, a is more than 0, and may be 0.10 or more, 0.20 or more, 0.30 or more, 0.40 or more, 0.50 or more, 0.60 or more, 0.70 or more, or more than 0.70, and a is less than 1.00, and may be 0.90 or less, 0.80 or less, or 0.70 or less. In the above chemical composition, b is 0 or more, and may be 0.01 or more, 0.02 or more, or 0.03 or more, and b is 0.20 or less, and may be 0.15 or less, or 0.10 or less. In the above chemical composition, x is more than 0.15, and may be 0.20 or more, and x is less than 0.35, and may be 0.30 or less, 0.25 or less, 0.20 or less. In the above chemical composition, y is more than 0.15, and may be 0.20 or more, 0.25 or more, 0.30 or more, 0.35 or more, or 0.40 or more, and y is less than 0.45, and may be 0.40 or less. Further, z is more than 0.25, and may be 0.30 or more, 0.35 or more, or 0.40 or more, and z is less than 0.55, and may be 0.50 or less, 0.45 or less, or 0.40 or less. The contribution of the element M to charge and discharge is small. In this regard, since p+q+r is less than 0.17 in the above chemical composition, a high charge-discharge capacity is easily secured. Further, p+q+r may be 0.16 or less, 0.15 or less, 0.14 or less, 0.13 or less, 0.12 or less, 0.11 or less, or 0.10 or less. Meanwhile, since the element M is contained, the O2-like structure is easily stabilized. In the above chemical composition, p+q+r is 0 or more, and may be 0.01 or more, 0.02 or more, 0.03 or more, 0.04 or more, 0.05 or more, 0.06 or more, 0.07 or more, 0.08 or more, 0.09 or more, or 0.10 or more. The composition of O is about 2, but is inconstant without being limited to just 2.0.

### 1.4 Others

For example, the electrode active material according to the embodiment may include a solid particle, may include a hollow particle, or may include a particle having a void. The size of the particle of the electrode active material is not particularly limited, but it is thought that a small size is advantageous. For example, the average particle diameter (D50) of the particle of the electrode active material may be 0.1 μm or more and 10 μm or less, 1.0 μm or more and 8.0 μm or less, or 2.0 μm or more and 6.0 μm or less. The average particle diameter (D50) is a particle diameter (D50, median diameter) at an integrated value of 50% in a volume-basis particle size distribution obtained by a laser diffracting/scattering method.

The electrode active material according to the embodiment may be a positive electrode active material. In the electrode active material according to the embodiment, since the crystallite size of the O2-like structure that is measured by XRD is 400 Å or more, the ratio of the capacity at a high potential to the total capacity increases, and the energy density easily improves. For example, in the embodiment, the ratio of a capacity at 3 V or higher to the total capacity is 75.0% or more. The ratio may be 85.0% or less, or 82.0% or less. A measurement method for the ratio of the capacity at 3 V or higher to the total capacity will be shown in Examples.

### 2. Production Method for Electrode Active Material

The electrode active material according to the embodiment can be produced by the following method, for example. The production method for the electrode active material according to the embodiment includes obtaining a Na-containing oxide having the P2-type structure (S1), and obtaining a Li-containing oxide having the O2-like structure by the contact of an ion-exchange material with the Na-containing oxide and the ion exchange of at least some of Na contained in the Na-containing oxide into Li (S2).

### 2.1 S1

In S1, for example, the Na-containing oxide having the P2-type structure can be produced through the following steps:
S11: obtaining a precursor
S12: obtaining a composite by coating the surface of the precursor with a Na source
S13: firing the composite.

Here, S13 may include:
S13-1: performing preliminary firing to the composite at a temperature of 300° C. or higher and lower than 700° C., for a time of 2 hours or more and 10 hours or less
S13-2: performing real firing to the composite at a temperature of 700° C. or higher and 1100° C. or lower, for a time of 30 minutes or more and 48 hours or less, subsequent to the preliminary firing
S13-3: rapidly cooling the composite from a temperature T₁ of 200° C. or higher to a temperature T₂ of 100° C. or lower, subsequent to the real firing.

### 2.1.1 Production of Precursor

The precursor may contain at least one element selected from among Mn, Ni, and Co, or may contain Mn, Ni, and Co. The precursor may be a salt that contains at least one element selected from among Mn, Ni, and Co. For example, the precursor may be at least one kind selected from among a carbonate, a sulfate, a nitrate, and an acetate. Alternatively, the precursor may be a compound other than the salt. For example, the precursor may be a hydroxide. The precursor may be a hydrate. The precursor may be a combination of a plurality of kinds of compounds. The precursor may have various shapes. For example, the precursor may have a particle shape, and may be a spherical particle as described later. The particle diameter of the particle of the precursor is not particularly limited.

In S11, a precipitation as the above precursor may be obtained by a coprecipitation method, using an ion source that can form a precipitation with a transition metal ion in an aqueous solution, and a transition metal compound that contains at least one element selected from among Mn, Ni, and Co. Thereby, a spherical particle as the precursor is easily obtained. For example, the “ion source that can form a precipitation with a transition metal ion in an aqueous solution” may be at least one kind selected from among a sodium salt such as sodium carbonate and sodium nitrate, sodium hydroxide, sodium oxide, and the like. The transition metal compound may be the above salt, hydroxide, and the like that contain at least one element selected from among Mn, Ni, and Co. Specifically, in S11, the precipitation as the precursor may be obtained by making solutions that respectively contain the ion source and the transition metal compound and dropping and mixing the respective solutions. On this occasion, for example, water is used as a solvent. On this occasion, various sodium compounds may be used as bases, and an ammonia aqueous solution or the like may be added for the adjustment of the base property. In the case of the coprecipitation method, for example, the precipitation as the precursor is obtained by preparing an aqueous solution of the transition metal compound and an aqueous solution of sodium carbonate and dropping and mixing the respective aqueous solutions. Alternatively, the precursor can be obtained by a sol-gel method. Particularly, by the coprecipitation method, the spherical particle as the precursor is easily obtained.

In S11, the precursor may contain the element M. The element M is at least one element selected from among B, Mg, Al, K, Ca, Ti, V, Cr, Cu, Zn, Ga, Ge, Sr, Y, Zr, Nb, Mo, and W. The elements have a function to stabilize the P2-type structure and the O2-like structure, for example. The method for obtaining the precursor containing the element M is not particularly limited. In the case where the precursor is obtained by the coprecipitation method in S11, for example, an aqueous solution of the transition metal compound that contains at least one element selected from among Mn, Ni, and Co, an aqueous solution of sodium carbonate, and an aqueous solution of a compound of the element M are prepared, and the respective aqueous solutions are dropped and mixed, so that the precursor that contains the element M together with at least one element selected from among Mn, Ni, and Co is obtained. Alternatively, in the production method in the present disclosure, the element M may be doped at the time of the firing described later, instead of the addition of the element M in S11.

### 2.1.2 Production of Composite

In S12, the composite is obtained by coating the surface of the precursor obtained in S11 with the Na source. The Na source may be a salt containing Na, as exemplified by a carbonate and a nitrate, or may be a compound other than the salt, as exemplified by sodium oxide and sodium hydroxide. In S12, the amount of the Na source with which the surface of the precursor is coated may be decided in consideration of a Na loss quantity at the time of the later firing. In S12, a Na source coating ratio of the surface of the precursor is not particularly limited. In S12, the method for coating the surface of the precursor with the Na source is not particularly limited. For example, the precursor and the Na source may be mixed using a mortar or a mixing device, or a solution containing the Na source may be caused to get contact with the precursor, and then may be dried, by a roll flow coating method, a spray dry method, or the like.

In S12, the precursor may be coated with an M source together with the Na source. For example, in S12, the composite may be obtained by mixing the precursor obtained in S11, the Na source, and an M source containing the element M that is at least one element selected from among B, Mg, Al, K, Ca, Ti, V, Cr, Cu, Zn, Ga, Ge, Sr, Y, Zr, Nb, Mo, and W. For example, the M source may be a salt containing the element M, as exemplified by a carbonate and a nitrate, may be a compound other than the salt, as exemplified by an oxide and a hydroxide. The amount of the M source for the precursor may be decided depending on the chemical composition of the Na-containing oxide after the firing.

### 2.1.3 Firing of Composite

In S13, the Na-containing oxide having the P2-type structure is obtained by firing the composite obtained in S12. S13 may include S13-1, S13-2, and S13-3. Conditions in S13-1, S13-2, and S13-3 are adjusted depending on a chemical composition for the O2-like structure that is finally obtained. Thereby, it is possible to adjust the crystallite size and shape (plate-shaped particle or spherical particle) of the P2-type Na-containing oxide that is obtained in S13, and it is possible to adjust the crystallite size of the O2-like structure that is finally obtained.

In S13-1, the preliminary firing is performed to the composite at a temperature of 300° C. or higher and lower than 700° C., for a time of 2 hours or more and 10 hours or less. In S13-1, the preliminary firing may be performed after the above composite is arbitrarily shaped. The preliminary firing is performed at a temperature lower than the temperature of the real firing. When the preliminary firing in S13-1 is insufficient, the generation of a P2 phase can become insufficient in the Na-containing oxide that is finally obtained. In S13-1, the preliminary firing temperature is 300° C. or higher and lower than 700° C., and the preliminary firing time is 2 hours or more and 10 hours or less. Thereby, the preliminary firing can be sufficiently performed to the composite, thermal uniformity is enhanced, and an appropriate Na-containing oxide is easily obtained through S13-2 and S13-3 described later. The preliminary firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. Further, the preliminary firing time may be 2 hours or more and 8 hours or less, 3 hours or more and 8 hours or less, 4 hours or more and 8 hours or less, 5 hours or more and 8 hours or less, or 5 hours or more and 7 hours or less. A preliminary firing atmosphere is not particularly limited, and may be an oxygen-containing atmosphere, for example.

In S13-2, the real firing is performed to the composite at a temperature of 700° C. or higher and 1100° C. or lower, for a time of 30 minutes or more and 48 hours or less, subsequent to the preliminary firing. In S13-2, the real firing temperature of the composite may be 800° C. or higher and 1000° C. or lower, or 850° C. or higher and 950° C. or lower. When the real firing temperature is too low, the P2 phase is not generated, and when the real firing temperature is too high, an 03 phase and the like are easily generated instead of the P2 phase. The condition for the temperature increase from the preliminary firing temperature to the real firing temperature is not particularly limited. In S13-2, by the real firing temperature and the real firing time, the shape and crystallite size of the Na-containing oxide can be controlled. When the real firing time is too short, the generation of the P2 phase becomes insufficient. On the other hand, when the real firing time is too long, the P2 phase excessively grows, and the crystallite easily coarsens.

In S13-3, the composite is rapidly cooled (at a temperature decreasing speed of 20° C./min or higher) from a temperature T₁ of 200° C. or higher to a temperature T₂ of 100° C. or lower, subsequent to the above real firing. The above preliminary firing and real firing are performed in a heating furnace, for example. In S13-3, for example, after the real firing of the composite is performed in the heating furnace, cooling is performed to an arbitrary temperature T₁ of 200° C. or higher in the heating furnace. After the temperature reaches the temperature T₁, the fired object is taken out of the heating furnace, and is rapidly cooled to an arbitrary temperature T₂ of 100° C. or lower in the exterior of the heating furnace. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower, or may be a cooling end temperature. In a predetermined temperature region from the temperature T₁ to the temperature T₂, moisture easily penetrates into between layers of the P2-type structure, due to atom vibration, molecular motion, and the like. It is thought that the penetration amount of moisture into between layers of the P2-type structure is reduced by shortening the time of such a temperature region in which moisture easily penetrates (that is, by performing rapid cooling), when the composite (the Na-containing oxide having the P2-type structure) after the real firing is cooled. In this regard, when the composite after the real firing is cooled in S13-3, radiational cooling is performed from the arbitrary temperature T₁ of 200° C. or higher to the arbitrary temperature T₂ of 100° C. or lower, under a dry atmosphere in the exterior of the heating furnace, for example. Thereby, the cooling speed from the temperature T₁ to the temperature T₂ becomes a high speed (for example, 20° C./min or higher). This makes it hard for moisture to penetrate into between layers of the P2-type structure, and makes it possible to restrain the collapse of the P2-type structure, and the like. As a result, it is possible to efficiently perform the ion exchange of Na into Li, in S2.

In S13, it is possible to produce a Na-containing oxide having the P2-type structure and having a predetermined chemical composition. The Na-containing oxide may contain at least Na, O, and at least one element selected from among Mn, Ni, and Co, as constituent elements. Particularly, in the case where the Na-containing oxide contains at least Na, Mn, at least one element selected from among Ni and Co, and O as constituent elements, especially, in the case where the Na-containing oxide contains at least Na, Mn, Ni, Co, and O as constituent elements, the performance of the electrode active material that is finally obtained easily becomes even higher. The Na-containing oxide may have a chemical composition shown as Na_{c}Niₓ₋ₚCo_{y-q}Mn_{z-r}M_{p+q+r}O₂. Here, 0<c<1.00, 0.15<x<0.35, 0.15<y<0.45, 0.25<z<0.55, x+y+z=1, and 0≤p+q+r<0.17 are satisfied. Further, M is at least one kind of element selected from among B, Mg, Al, K, Ca, Ti, V, Cr, Fe, Cu, Zn, Ga, Ge, Sr, Y, Zr, Nb, Mo, and W. In the case where the Na-containing oxide has this chemical composition, the P2-type structure is easily maintained. In the above chemical composition, c is more than 0, and may be 0.10 or more, 0.20 or more, 0.30 or more, 0.40 or more, 0.50 or more, or 0.60 or more, and c is less than 1.00, and may be 0.90 or less, 0.80 or less, or 0.70 or less. Further, x, y, z, and p+q+r have been described above. The composition of O is about 2, but is inconstant without being limited to just 2.0.

### 2.2 S2

In S2, the Li-containing oxide having the O2-like structure is obtained by the contact of the ion-exchange material with the Na-containing oxide obtained in S1 and the ion exchange of at least some of Na contained in the Na-containing oxide into Li. As the ion-exchange material, for example, a Li compound is used. Specifically, a lithium salt such as lithium nitrate and lithium halide may be used as the ion-exchange material. When the above ion-exchange material is caused to get contact with the Na-containing oxide, the ion-exchange material may be in a molten state, or may be in a solid state. Particularly, the molten state is preferable. That is, the Na-containing oxide having the above P2-type structure and the ion-exchange material are mixed, and are heated to a temperature higher than or equal to the melting point of the ion-exchange material. Thereby, it is possible to perform the ion exchange of at least some of Na in the Na-containing oxide into Li. For example, the temperature in the ion exchange may be higher than or equal to the melting point of the above ion-exchange material and 600° C. or lower, 500° C. or lower, 400° C. or lower, or 300° C. or lower. When the temperature in the ion exchange is too high, the O3-type structure, which is a stabilized phase, is easily generated instead of the O2-like structure. On the other hand, from the standpoint of the reduction in the time spent on the ion exchange, it is preferable that the temperature in the ion exchange be as high as possible.

### 3. Battery

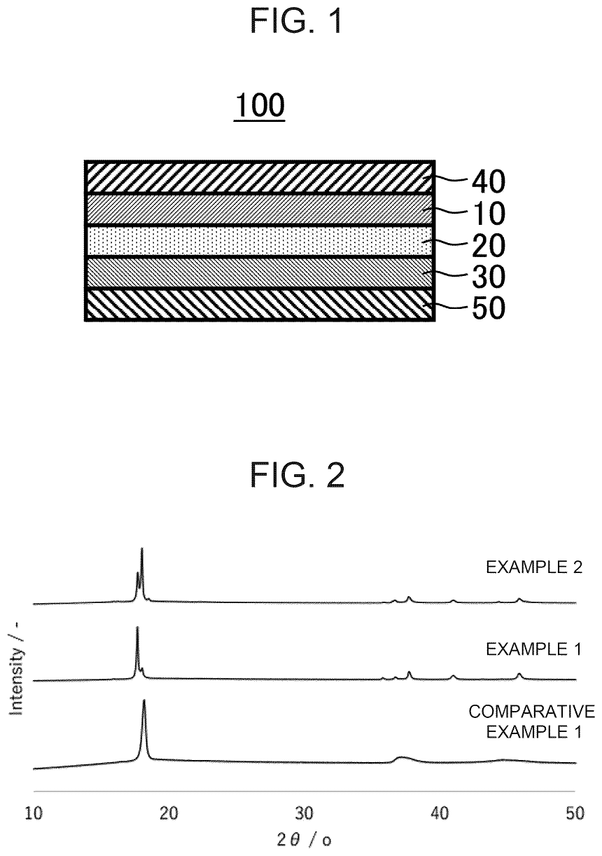

As shown in FIG. 1, a battery 100 according to the embodiment includes a positive electrode active material layer 10, an electrolyte layer 20, and a negative electrode active material layer 30. In the battery 100, for example, the positive electrode active material layer 10 can contain the electrode active material in the present disclosure. The battery 100 can include a positive electrode current collector 40 and a negative electrode current collector 50. The battery 100 may be a solid-state battery, or may be a liquid-state battery. The solid-state battery means a battery that contains a solid electrolyte, and may contain liquid. The battery 100 may be an all-solid-state battery that does not substantially liquid. The configuration of the battery may be the same as conventional configurations, except that the electrode active material in the present disclosure is employed. Detailed descriptions are omitted.

The embodiment of the electrode active material and the like has been described above. Other than the above embodiment, the technology in the present disclosure can be variously modified without departing from the spirit of the present disclosure. The technology in the present disclosure will be described below in more detail, with examples. The technology in the present disclosure is not limited to examples described below.

### 1. Production of Electrode Active Material

### 1.1 Example 1

### 1.1.1 Production of Precursor Particle

(1) NiSO₄·6H₂O, CoSO₄·7H₂O, and MnSO₄·5H₂O were weighed at an intended composition ratio (Ni:Co:Mn=2:4:4), and were dissolved in distilled water at a concentration of 1.2 mol/L, so that a first solution was obtained. Further, in another container, Na₂CO₃ was dissolved in distilled water at a concentration of 1.2 mol/L, so that a second solution was obtained.

(2) 1000 mL of pure water was put in a reaction container (with a baffle plate), and 500 mL of the first solution and 500 mL of the second solution each were dropped in the reaction container at a speed of about 4 mL/min.

(3) After the end of the dropping, stirring was performed at room temperature at a stirring speed of 150 rpm for 1 hour, so that a product was obtained.

(4) The product was washed by pure water, solid-liquid separation was performed by a centrifugal separator, and a precipitation was collected.

(5) The obtained precipitation was dried at 120° C. overnight, was ground with a mortar, and thereafter, coarse particles and fine particles were removed by airflow classification, so that precursor particles were obtained.

### 1.1.2 Production of Composite

The obtained precursor particles and Na₂CO₃ were mixed in a mortar, and surfaces of the precursor particles were coated with Na₂CO₃, so that a composite was obtained.

### 1.1.3 Firing of Composite

The composite was put in an alumina crucible, and firing was performed under an air atmosphere, so that a Na-containing oxide having the P2-type structure was obtained. The firing condition is shown as the following (1) to (5).

(1) An alumina crucible containing the above composite is installed in a heating furnace under the air atmosphere.

(2) The temperature in the heating furnace is increased from the room temperature (25° C.) to 600° C. for 115 minutes.

(3) The preliminary firing is performed while the interior of the heating furnace is kept at 600° C. for 360 minutes.

(4) The temperature in the heating furnace is increased to 900° C. after the preliminary firing, and then the real firing is performed while the interior of the heating furnace is kept at 900° C. for 12 hours.

(5) The temperature in the heating furnace is decreased from the real firing temperature to 250° C. after the real firing, the alumina crucible is taken out of the heating furnace at 250° C., and radiational cooling is performed in the exterior of the heating furnace under a dry atmosphere, such that the temperature reaches 25° C. for 10 minutes.

The fired object after the radiational cooling was ground under the dry atmosphere using a mortar, so that Na-containing oxide particles (P2-type particles) having the P2-type structure were obtained. The P2-type particle was a plate-shaped particle having a chemical composition shown as Na_{0.8}Ni_{0.2}Co_{0.4}Mn_{0.4}O₂.

### 1.1.4 Ion Exchange

(1) LiNO₃ and LiCl were weighed at a mole ratio of 50:50, and were mixed with the above P2-type particles at a mole ratio of 10 times the minimum Li amount necessary for the ion exchange, so that a mixture was obtained.

(2) The ion exchange was performed at 280° C. under the air atmosphere for 1 hour, using an alumina crucible, so that a product containing a Li-containing oxide was obtained.

(3) Salts remaining in the product were washed by pure water, and solid-liquid separation was performed by vacuum filtration, so that a precipitation was obtained.

(4) The obtained precipitation was dried at 120° C. overnight, so that electrode active material particles according to Example 1 were obtained. The electrode active material particle was a plate-shaped particle having a chemical composition shown as Li_{0.67}Ni_{0.2}Co_{0.4}Mn_{0.4}O₂.

### 1.2 Example 2

### 1.2.1 Production of Precursor Particle

Precursor particles were obtained similarly to Example 1.

### 1.2.2 Production of Composite

(1) Na₂CO₃ and distilled water were weighed such that the concentration was 1150 g/L, and thereafter, were stirred using a stirrer, so as to be completely dissolved, so that a Na₂CO₃ aqueous solution was produced.

(2) The above Na₂CO₃ aqueous solution and the above precursor particles were weighed and mixed such that the composition after firing described later was Na_{0.8}Ni_{0.2}Co_{0.4}Mn_{0.4}O₂, so that a slurry was obtained.

(3) The flash drying of the above slurry was performed by spray dry, so that a composite was obtained. Specifically, the flash drying of the above slurry was performed using a spray dry device DL410, under the following conditions: a slurry sending speed of 30 ml/min, an entrance temperature of 200° C., a circulation air volume of 0.8 m³/min, and a spraying pressure of 0.3 MPa, and thereby, the surfaces of the precursor particles were coated with Na₂CO₃, so that the composite was obtained.

### 1.2.3 Firing of Composite

The firing and radiational cooling of the above composite were performed similarly to Example 1, except that the above composite was used, and the fired object after the radiational cooling was ground under the dry atmosphere using a mortar, so that Na-containing oxide particles (P2-type particles) having the P2-type structure were obtained. The P2-type particle was a spherical particle having a chemical composition shown as Na_{0.8}Ni_{0.2}Co_{0.4}Mn_{0.4}O₂.

### 1.2.4 Ion Exchange

The ion exchange was performed similarly to Example 1, except that the above P2-type particles were used, so that electrode active material particles according to Example 2 were obtained. The electrode active material particle was a spherical particle having a chemical composition shown as Li_{0.64}Ni_{0.2}Co_{0.4}Mn_{0.4}O₂.

### 1.3 Example 3

### 1.3.1 Production of Precursor Particle

Precursor particles were produced similarly to Example 2, except that the raw materials were mixed such that the composition ratio was Ni:Co:Mn 3:3:4.

### 1.3.2 Production of Composite

A composite was obtained by spray dry similarly to Example 2, except that the above precursor particles were used.

### 1.3.3 Firing of Composite

The firing and the radiational cooling were performed under the conditions similar to Example 2, except that the above composite was used and the real firing time of the composite was altered to 1 hour, and the fired object after the radiational cooling was ground under the dry atmosphere using a mortar, so that Na-containing oxide particles (P2-type particles) having the P2-type structure were obtained. The P2-type particle was a spherical particle having a chemical composition shown as Na_{0.9}Ni_{0.3}Co_{0.3}Mn_{0.4}O₂.

### 1.3.4 Ion Exchange

The ion exchange was performed similarly to Example 1, except that the above P2-type particles were used, so that electrode active material particles according to Example 3 were obtained. The electrode active material particle was a spherical particle having a chemical composition shown as Li_{0.65}Ni_{0.3}Co_{0.3}Mn_{0.4}O₂.

### 1.4 Example 4

### 1.4.1 Production of Precursor Particle

Precursor particles were produced similarly to Example 2, except that the raw materials were mixed such that the composition ratio was Ni:Co:Mn 3:2:5.

### 1.4.2 Production of Composite

A composite was obtained by spray dry similarly to Example 2, except that the above precursor particles were used.

### 1.4.3 Firing of Composite

The firing and the radiational cooling were performed under the conditions similar to Example 2, except that the above composite was used and the real firing time of the composite was altered to 1 hour, and the fired object after the radiational cooling was ground under the dry atmosphere using a mortar, so that Na-containing oxide particles (P2-type particles) having the P2-type structure were obtained. The P2-type particle was a spherical particle having a chemical composition shown as Na_{0.8}Ni_{0.3}Co_{0.2}Mn_{0.5}O₂.

### 1.4.4 Ion Exchange

The ion exchange was performed similarly to Example 1, except that the above P2-type particles were used, so that electrode active material particles according to Example 4 were obtained. The electrode active material particle was a spherical particle having a chemical composition shown as Li_{0.66}Ni_{0.3}Co_{0.2}Mn_{0.5}O₂.

### 1.5 Comparative Example 1

### 1.5.1 Production of Precursor Particle and Composite

Precursor particles and a composite were produced similarly to Example 2.

### 1.5.2 Firing of Composite

The firing and the radiational cooling were performed under the conditions similar to Example 2, except that the firing temperature of the composite was altered to 800° C., and the fired object after the radiational cooling was ground under the dry atmosphere using a mortar, so that Na-containing oxide particles (P2-type particles) having the P2-type structure were obtained. The P2-type particle was a spherical particle having a chemical composition shown as Na_{0.8}Ni_{0.2}Co_{0.4}Mn_{0.4}O₂.

### 1.5.3 Ion Exchange

The ion exchange was performed similarly to Example 1, except that the above P2-type particles were used, so that electrode active material particles according to Comparative Example 1 were obtained. The electrode active material particle was a spherical particle having a chemical composition shown as Li_{0.64}Ni_{0.2}Co_{0.4}Mn_{0.4}O₂.

### 1.6 Comparative Example 2

Precursor particles and a composite were produced similarly to Example 3.

### 1.6.2 Firing of Composite

The firing and the radiational cooling were performed under the conditions similar to Example 3, except that the firing temperature of the composite was altered to 800° C., and the fired object after the radiational cooling was ground under the dry atmosphere using a mortar, so that Na-containing oxide particles (P2-type particles) having the P2-type structure were obtained. The P2-type particle was a spherical particle having a chemical composition shown as Na_{0.9}Ni_{0.3}Co_{0.3}Mn_{0.4}O₂.

### 1.6.3 Ion Exchange

The ion exchange was performed similarly to Example 1, except that the above P2-type particles were used, so that electrode active material particles according to Comparative Example 2 were obtained. The electrode active material particle was a spherical particle having a chemical composition shown as Li_{0.65}Ni_{0.3}Co_{0.3}Mn_{0.4}O₂.

### 1.7 Summary of Condition

Table 1 shows a summary of the production conditions for the respective P2-type particles in Examples 1 to 4 and Comparative Examples 1 and 2.

TABLE 1

| | | Composite | Composite | Composite | | P2-type |
|---|---|---|---|---|---|---|
| | | Production | Firing | Firing | | Particle |
| | Me Composition | Condition | Temperature | Time | | Composition |
| Example 1 | Ni:Co:Mn = 2:4:4 | Mortar mixing | 900° C. | 12 | hours | Na0.8MeO2 |
| Example 2 | Ni:Co:Mn = 2:4:4 | Spray dry | 900° C. | 12 | hours | Na0.8MeO2 |
| Example 3 | Ni:Co:Mn = 3:3:4 | Spray dry | 900° C. | 1 | hour | Na0.9MeO2 |
| Example 4 | Ni:Co:Mn = 3:2:5 | Spray dry | 900° C. | 1 | hour | Na0.8MeO2 |
| Comparative | Ni:Co:Mn = 2:4:4 | Spray dry | 800° C. | 1 | hour | Na0.8MeO2 |
| Example 1 | | | | | | |
| Comparative | Ni:Co:Mn = 3:3:4 | Spray dry | 800° C. | 1 | hour | Na0.9MeO2 |
| Example 2 | | | | | | |

### 2. Production of Coin Cell

A coin cell (CR2032) was produced using each electrode active material. A production procedure for the coin cell is shown as follows.

(1) The above electrode active material layer, acetylene black (AB) as a conduction aid, polyvinylidene fluoride (PVdF) as a binder were weighed such that the mass ratio is electrode active material:AB:PVdF=85:10:5, and were dispersed and mixed in N-methyl-2-pyrrolidone, so that a positive electrode composite material slurry was obtained. An aluminum foil was coated with the positive electrode composite material slurry, and vacuum drying was performed at 120° C. overnight, so that a positive electrode that is a laminated object of a positive electrode active material layer and a positive electrode current collector was obtained.

(2) LiPF₆ was dissolved at a concentration of 1 M in a mixed solution in which trifluoropropylene carbonate (TFPC) and trifluoroethylmethyl carbonate (TFEMC) were mixed at a ratio of TFPC:TFEMC=30 vol %:70 vol %, so that an electrolytic solution was obtained.

(3) A metal lithium foil was prepared as a negative electrode.

(4) The coin cell (CR2032) was produced using the positive electrode, the electrolytic solution, and the negative electrode.

### 3. Evaluation Method

### 3.1 Crystallite Size

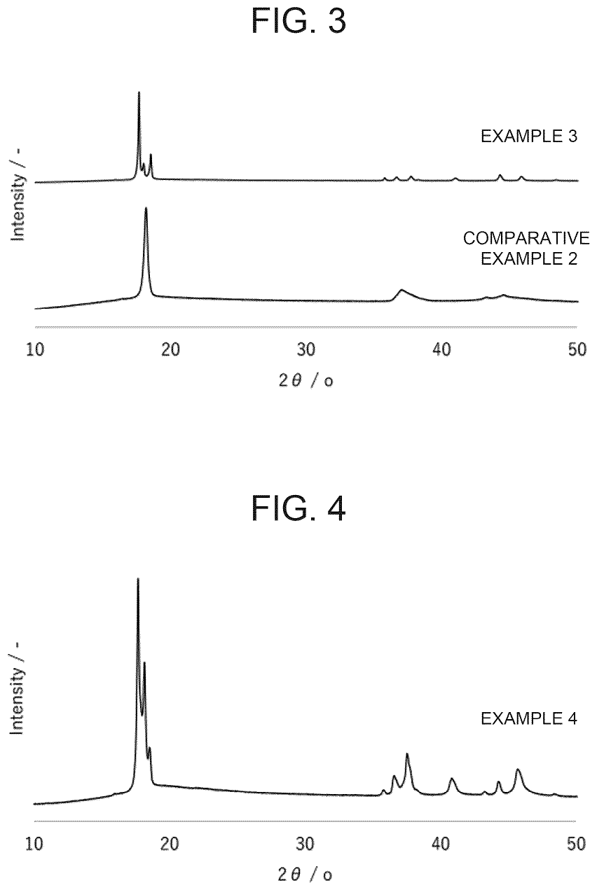

An X-ray diffraction pattern for which CuKα was used as a radiation source was acquired about each electrode active material. FIG. 2 shows X-ray diffraction patterns of the electrode active materials according to Examples 1 and 2 and Comparative Example 1. FIG. 3 shows X-ray diffraction patterns of the electrode active materials according to Example 3 and Comparative Example 2. FIG. 4 shows an X-ray diffraction pattern of the electrode active material according to Example 4. As shown in FIGS. 2 to 4, each of the electrode active materials according to Examples 1 to 4 and Comparative Examples 1 and 2 had the O2-like structure. In each X-ray diffraction pattern, the crystallite size of the O2-like structure was evaluated from an X-ray diffraction peak deriving from the (002) plane of the O2-type structure, an X-ray diffraction peak deriving from the (002) plane of the T#2-type structure, or an X-ray diffraction peak deriving from the (006) plane of the O6-type structure, based on the Scherrer formula, using PDXL2 software (made by Rigaku Corporation). In the case where a plurality of X-ray diffraction peaks of the X-ray diffraction peak deriving from the (002) plane of the O2-type structure, the X-ray diffraction peak deriving from the (002) plane of the T#2-type structure, and the X-ray diffraction peak deriving from the (006) plane of the O6-type structure was observed in the X-ray diffraction pattern, the crystallite diameter was evaluated based on a main peak (a peak having the highest peak intensity) of the plurality of peaks.

### 3.2 Electrochemical Measurement

For each coin cell, charge and discharge were performed at 0.1 C rate (1C=220 mA/g) in a voltage range of 2.0 V to 4.8 V, in a constant-temperature bath kept at 25° C., an initial discharge capacity was measured, and the ratio of a capacity at 3 V or higher to the initial discharge capacity was calculated.

### 4. Evaluation Result

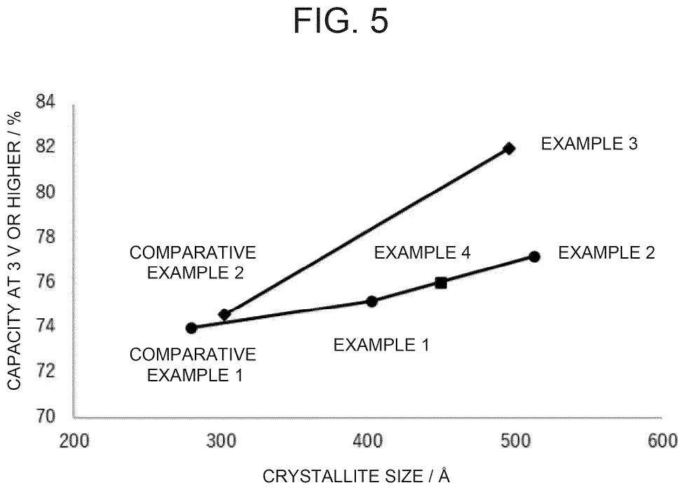

Table 2 shows the transition metal composition, the crystallite size of the O2-like structure, the initial discharge capacity, and the ratio of the capacity at 3 V or higher to the discharge capacity (total capacity) about the respective electrode active materials in Examples 1 to 4 and Comparative Examples 1 and 2. Further, FIG. 5 shows the relation between the crystallite size of the O2-like structure that is measured by XRD and the ratio of the capacity at 3 V or higher to the total capacity.

TABLE 2

| | | | Discharge | |
|---|---|---|---|---|
| | | Crystallite | Capacity | 3-V Capacity |
| | Me Composition | Size (Å) | (mAh/g) | Ratio (%) |
| Example 1 | Ni:Co:Mn = 2:4:4 | 403 | 238 | 75.2 |
| Example 2 | Ni:Co:Mn = 2:4:4 | 513 | 243 | 77.2 |
| Example 3 | Ni:Co:Mn = 3:3:4 | 496 | 231 | 82.0 |
| Example 4 | Ni:Co:Mn = 3:2:5 | 450 | 220 | 76.0 |
| Comparative | Ni:Co:Mn = 2:4:4 | 280 | 248 | 74.0 |
| Example 1 | | | | |
| Comparative | Ni:Co:Mn = 3:3:4 | 302 | 236 | 74.6 |
| Example 2 | | | | |

From the results shown in Table 2 and FIG. 5, it is found that the ratio of a high-potential capacity to the total capacity of the electrode active material is high when the crystallite size of the O2-like structure in the electrode active material is 400 Å or more. When the crystallite size is more than 1000 Å, it is sometimes difficult to measure the crystallite size by XRD. In this regard, the upper limit of the crystallite size of the O2-like structure in the electrode active material in the present disclosure is 1000 Å or less.

What is claimed is:

1. An electrode active material having at least one O2-like structure selected from the group consisting of an O2-type structure, a T#2-type structure, and an O6-type structure, wherein
a crystallite size of the O2-like structure is 400 Å or more and 1000 Å or less, the crystallite size being measured by XRD.

2. The electrode active material according to claim 1, wherein a ratio of a capacity at 3 V or higher to a total capacity is 75.0% or more.

3. The electrode active material according to claim 1, wherein the electrode active material contains Li, O, and at least one element selected from the group consisting of Ni, Mn, and Co, as constituent elements.

4. The electrode active material according to claim 3, wherein the electrode active material has a chemical composition shown as LiₐNa_{b}Niₓ₋ₚCo_{y-q}Mn_{z-r}M_{p+q+r}O₂ (0<a<1.00, 0≤b≤0.20, 0.15<x<0.35, 0.15<y<0.45, 0.25<z<0.55, x+y+z=1, 0≤p+q+r<0.17, and an element M is at least one element selected from the group consisting of B, Mg, Al, K, Ca, T₁, V, Cr, Fe, Cu, Zn, Ga, Ge, Sr, Y, Zr, Nb, Mo, and W).

5. The electrode active material according to claim 4, wherein 0.70<a<1.00 is satisfied.
